(19) United States
(12) Patent Application Publication
(10) Pub. No.: US 2015/0062390 A1
(43) Pub. Date: Mar. 5, 2015

(54) PHASE DIFFERENCE DETECTION PIXEL USING MICROLENS

(71) Applicant: SiliconFile Technologies Inc., Seongnam-si (KR)

(72) Inventors: Ho Soo KIM, Yongin-si (KR); Jong Phil Kim, Seongnam-si (KR)

(21) Appl. No.: 14/474,550

(22) Filed: Sep. 2, 2014

(30) Foreign Application Priority Data
Sep. 3, 2013 (KR) 10-2013-0105616

(51) Int. Cl. H04N 5/232; G02B 3/00; H04N 9/077

(52) U.S. Cl. CPC H04N 5/23212; H04N 9/077; G02B 3/0037
USPC 348/273

(57) ABSTRACT

Disclosed is a phase difference detection pixel using a microlens, which detects a phase difference without the loss of an input signal by modifying the shape of a microlens, which collects light incident into a photodiode, such that the light passes through only in a specific direction. In the phase difference detection pixel using a microlens, a signal reduction problem, which is a disadvantage of the existing phase difference detection pixel, is solved and a phase difference detection function is achieved in all areas of an image sensor. The phase difference detection pixel using a microlens is variously applied for distance measurement between objects or three-dimensional image capturing.

### BACKGROUND

1. Technical Field

The present disclosure relates to a phase difference detection pixel, and more particularly, to a phase difference detection pixel using a microlens, which can detect a phase difference without the loss of an input signal by modifying the shape of a microlens, which collects light incident into a photodiode, such that the light can pass through only in a specific direction.

2. Related Art

A phase difference detection apparatus using pixels of an image sensor has a structure in which a pair of two pixels having the same color block different areas of an upper end of a photodiode by using a specific material such that light can be incident only in a specific direction.

In this case, when it is out of focus, a phase difference occurs in the pair of pixels as described above, so that it is possible to produce a camera capable of automatically adjusting the focus by using the phase difference without a separate phase difference auto focus (AF) sensor module.

However, when a partial area of the upper end of the photodiode is blocked in order to detect a phase difference, there is a problem that the amount of signals introduced from an exterior is reduced.

In a camera using a phase difference detection pixel, since tens of thousands of corresponding pixels are arranged, when signals of peripheral pixels are used in order to solve the signal reduction problem, there is a problem that a resolution may be reduced.

A conventional phase difference AF apparatus includes photodiodes that convert an external image into an electrical signal, and black masks that allow only light incident in a specific direction to be selectively collected in the photodiodes.

In this case, in order to generate a phase difference, the black masks are put on two photodiodes in an opposite direction to produce a pair, and tens of thousands of pairs are arranged in an image sensor, so that phase difference AF is obtained.

However, in order to generate a phase difference, since the black mask should be arranged on an upper portion of a specific area of the photodiode to block light incident into the photodiode, there is a problem that input information may be lost and an overall resolution may be reduced.

### SUMMARY

Various embodiments are directed to a phase difference detection pixel using a microlens, which can detect a phase difference without the loss of an input signal by modifying the shape of a microlens, which collects light incident into a photodiode, such that the light can pass through only in a specific direction.

In an embodiment, a phase difference detection pixel using a microlens includes: photodiodes formed in a semiconductor substrate; a metal interconnection layer formed on the photodiodes; an insulating layer formed on the metal interconnection layer; a color filter layer formed on the insulating layer and including a general color filter and a pair of color filters for phase difference detection; and a microlens layer including a general microlens formed on the general color filter and microlenses for phase difference detection formed on the pair of color filters for phase difference detection, wherein the microlenses for phase difference detection include: a first microlens for phase difference detection having a shape obtained by quartering a convex lens about a center of the convex lens in a horizontal direction and a vertical direction and provided at one side thereof with a first incidence surface inclined and curved; and a second microlens for phase difference detection having a shape obtained by quartering the convex lens about the center of the convex lens in the horizontal direction and the vertical direction and provided with a second incidence surface inclined and curved in an opposite direction of the first microlens for phase difference detection, wherein the microlenses for phase difference detection are formed with respect to the color filters for phase difference detection such that light incident in a specific direction is collected in the photodiodes corresponding to the color filters for phase difference detection.

In an embodiment, a phase difference detection pixel using a microlens includes: photodiodes formed in a semiconductor substrate; a metal interconnection layer formed on the photodiodes; an insulating layer formed on the metal interconnection layer; a color filter layer formed on the insulating layer and including a general color filter and a pair of color filters for phase difference detection; and a microlens layer including a general microlens formed on the general color filter and microlenses for phase difference detection formed on the pair of color filters for phase difference detection, wherein the microlenses for phase difference detection include: a first microlens for phase difference detection having a shape obtained by quartering a concave lens about a center of the concave lens in a horizontal direction and a vertical direction and provided at one side thereof with a first incidence surface inclined and curved; and a second microlens for phase difference detection having a shape obtained by quartering the concave lens about the center of the concave lens in the horizontal direction and the vertical direction and provided with a second incidence surface inclined and curved in an opposite direction of the first microlens for phase difference detection, wherein the microlenses for phase difference detection are formed with respect to the color filters for phase difference detection such that light incident in a specific direction is collected in the photodiodes corresponding to the color filters for phase difference detection.

In an embodiment, a phase difference detection pixel using a microlens includes: photodiodes formed in a semiconductor substrate; a metal interconnection layer formed on the photodiodes; an insulating layer formed on the metal interconnection layer; a color filter layer formed on the insulating layer and including a general color filter and a pair of color filters for phase difference detection; and a microlens layer including a general microlens formed on the general color filter and microlenses for phase difference detection formed on the pair of color filters for phase difference detection, wherein the microlenses for phase difference detection are vertically spaced apart from an upper portion of the pair of color filters for phase difference detection by a predetermined distance in an opposite direction on a basis of the general microlens.

In an embodiment, a phase difference detection pixel using a microlens includes: photodiodes formed in a semiconductor substrate; a metal interconnection layer formed on the photodiodes; an insulating layer formed on the metal interconnection layer; a color filter layer formed on the insulating layer and including a general color filter and a color filter for phase difference detection; and a microlens layer including a general microlens formed on the general color filter, and one microlens for phase difference detection formed on the color filter for phase difference detection and formed with respect to the color filter for phase difference detection such that light incident in a specific direction is collected in the photodiodes corresponding to the color filter for phase difference detection, wherein the one microlens for phase difference detection is formed with respect to at least two color filters for phase difference detection, and a protective layer is further provided between the insulating layer and the color filter layer.

In accordance with the phase difference detection pixel using a microlens according to the present invention, it is possible to solve a signal reduction problem that is a disadvantage of the existing phase difference detection pixel, and to achieve a phase difference detection function in all areas of an image sensor.

Furthermore, it is advantageous that the phase difference detection pixel using a microlens according to the present invention can be variously applied for distance measurement between objects or three-dimensional image capturing, as well as a function of simply detecting a phase difference.

### BRIEF DESCRIPTION OF THE DRAWINGS

FIG. 1 is a diagram illustrating an embodiment of a phase difference detection pixel using a microlens according to the present invention.

FIG. 2A and FIG. 2B are a diagram illustrating another embodiment of a phase difference detection pixel using a microlens according to the present invention.

FIG. 3 is a diagram illustrating further another embodiment of a phase difference detection pixel using a microlens according to the present invention.

FIG. 4 is a diagram illustrating further another embodiment of a phase difference detection pixel using a microlens according to the present invention.

FIG. 5 is a diagram illustrating further another embodiment of a phase difference detection pixel using a microlens according to the present invention.

FIG. 6 is a diagram illustrating further another embodiment of a phase difference detection pixel using a microlens according to the present invention.

FIGS. 7A and 7B are a diagram illustrating further another embodiment of a phase difference detection pixel using a microlens according to the present invention.

FIG. 8A and FIG. 8B are a diagram illustrating further another embodiment of a phase difference detection pixel using a microlens according to the present invention.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

According to the present invention, an image sensor having a phase difference detection function includes a microlens with a structure in which light can be incident only in a specific direction at an upper portion of a photodiode with respect to two pixels having the same color, so that a phase difference is detected and focus is automatically adjusted.

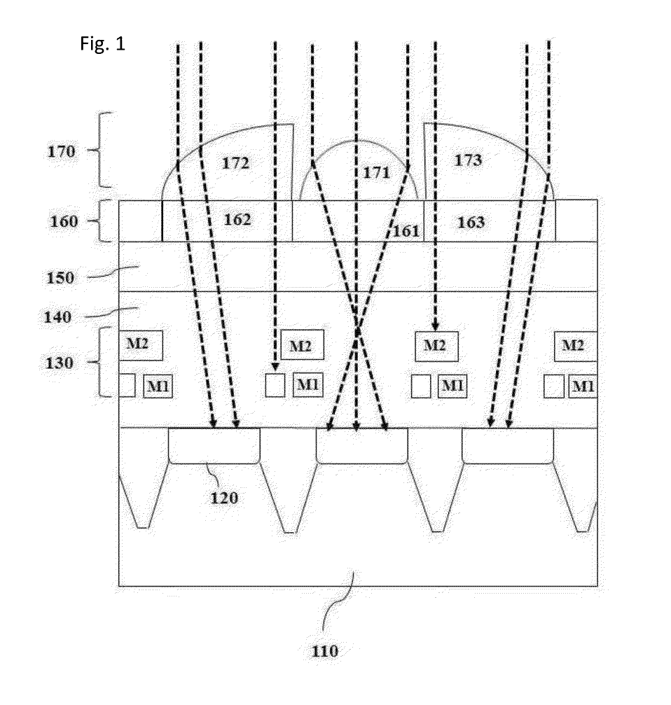

FIG. 1 is a diagram illustrating an embodiment of a phase difference detection pixel using a microlens according to the present invention.

Referring to FIG. 1, the phase difference detection pixel using a microlens according to the present invention includes photodiodes 120 formed in a semiconductor substrate 110, a metal interconnection layer 130 formed on the photodiodes 120 and including first metal interconnections M1 and second metal interconnections M2, an insulating layer 140 formed on the first metal interconnections M1 and the second metal interconnections M2, and a protective layer 150 formed on the insulating layer 140.

A color filter layer 160 is formed on the protective layer 150 and a microlens 170 is formed on the color filter layer 160.

The color filter layer 160 includes a general color filter 161 and a pair of color filters 162 and 163 for phase difference detection, which have the same color.

The microlens 170 includes a general microlens 171 and a pair of microlenses 172 and 173 for phase difference detection.

In the phase difference detection pixel using a microlens according to the present invention, in order to overcome the loss of signals input to the photodiodes, the shapes of the microlenses for phase difference detection, which collect light in the photodiodes, are variously modified.

FIG. 1 illustrates the microlenses for phase difference detection, which use a partial surface of a convex lens.

That is, the microlenses for phase difference detection include a first microlens 172 for phase difference detection and a second microlens 173 for phase difference detection.

The first microlens 172 for phase difference detection has a shape obtained by quartering the convex lens about the center of the convex lens in a horizontal direction and a vertical direction, and is provided at one side thereof with a first incidence surface inclined and curved.

The second microlens 173 for phase difference detection has a shape obtained by quartering the convex lens about the center of the convex lens in the horizontal direction and the vertical direction, and is provided with a second incidence surface inclined and curved in an opposite direction of the first microlens 172 for phase difference detection.

In the present invention, the shape of the microlens for phase difference detection corresponding to the same color of a color filter (for example, a green color filter) is configured to use only one surface of a convex lens, so that only light incident from the right and left or the upper and lower areas is collected in the photodiodes 120.

In the phase difference detection pixel using a microlens according to the present invention, it is preferable that the microlens for phase difference detection is manufactured to have the radius of curvature of 0.5 mm to 1.5 mm such that light incident in the range of 0° to 120° can be collected only in one direction.

In the case of adjusting the direction of light incident according to a chief ray angle (CRA) of an imaging lens, the size of the microlens for phase difference detection may be adjusted for use.

The microlens structure used in the phase difference detection pixel using a microlens according to the present invention can be applied to a front side illumination (FSI) image sensor and a back side illumination (BSI) image sensor.

The phase difference detection pixel using a microlens according to the present invention can be applied to obtain a phase difference AF function regardless of arrangement positions in the center and outer peripheral areas of an image sensor.

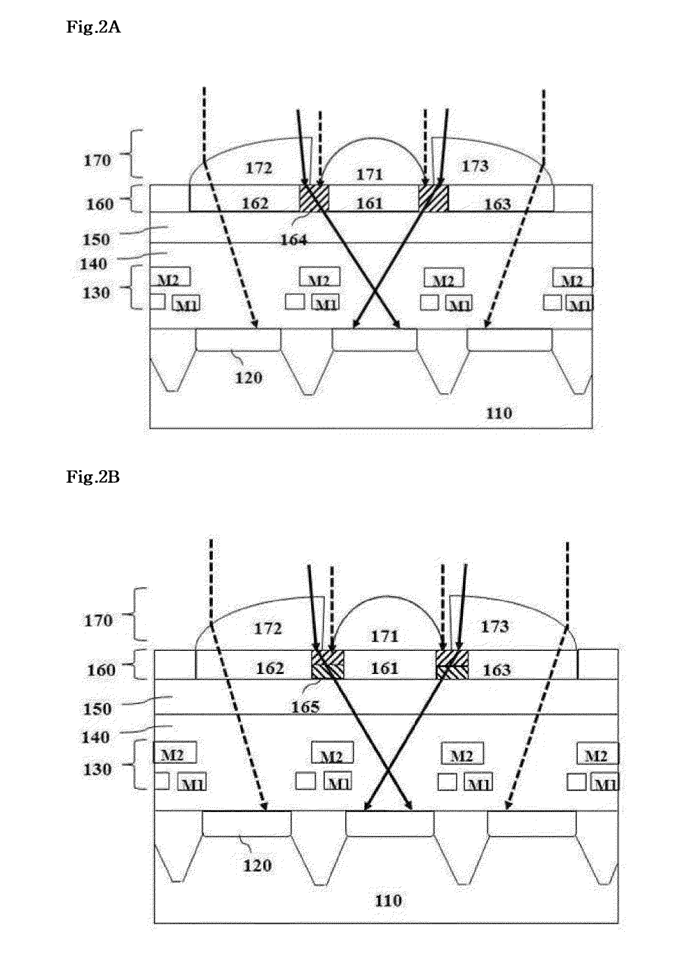

FIG. 2A and FIG. 2B are a diagram illustrating another embodiment of a phase difference detection pixel using a microlens according to the present invention.

In the phase difference detection pixel using a microlens according to the present invention, when light having a very large incident angle of 30° or more is incident, crosstalk may occur by microlenses for phase difference detection manufactured to have specific directions as indicated by solid lines in FIG. 2A and FIG. 2B.

In order to solve such a problem, it is preferable to further provide blocking layers 164 for blocking light between color filters as illustrated in FIG. 2A, or to further provide separate stack filters 165 as illustrated in FIG. 2B.

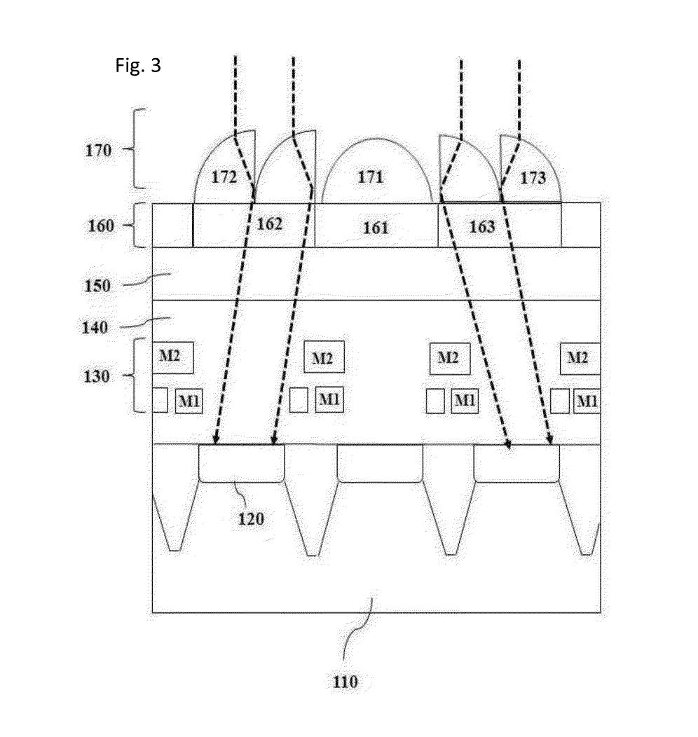

FIG. 3 is a diagram illustrating further another embodiment of a phase difference detection pixel using a microlens according to the present invention.

Referring to FIG. 3, two microlenses 172 and 173 for phase difference detection are formed such that the signal size of the phase difference detection pixel is increased and light can be collected only in a specific direction in order to minimize noise.

FIG. 3 illustrates the two microlenses 172 and 173 for phase difference detection for the purpose of convenience, but it is of course that the number of the microlenses can be expanded to two or more.

When light having a very large incident angle is incident as illustrated in FIG. 2A and FIG. 2B, since signals are collected in an adjacent pixel by the microlenses for phase difference detection manufactured to have specific directions, crosstalk occurs, and thus the efficiency of an image sensor may be reduced.

In order to solve such a problem, instead of one microlens for phase difference detection, two or more small microlenses for phase difference detection are arranged as illustrated in FIG. 3, so that it is possible to improve the signal size and the noise problem.

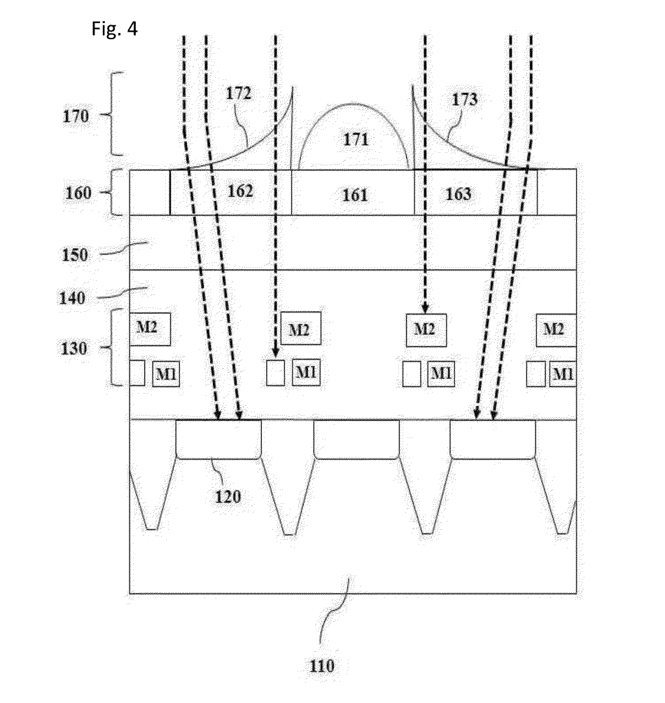

FIG. 4 is a diagram illustrating further another embodiment of a phase difference detection pixel using a microlens according to the present invention.

Referring to FIG. 4, in the phase difference detection pixel using a microlens according to the present invention, microlenses for phase difference detection have a concave lens shape, and only light incident in a specific direction can be collected in photodiodes 120 by using only one surface of the concave lens.

The microlenses for phase difference detection include a first microlens 172 for phase difference detection and a second microlens 173 for phase difference detection.

The first microlens 172 for phase difference detection has a shape obtained by quartering the concave lens about the center of the concave lens in a horizontal direction and a vertical direction, and is provided at one side thereof with a first incidence surface inclined and curved.

The second microlens 173 for phase difference detection has a shape obtained by quartering the concave lens about the center of the concave lens in the horizontal direction and the vertical direction, and is provided with a second incidence surface inclined and curved in an opposite direction of the first microlens 172 for phase difference detection.

In the phase difference detection pixel using a microlens according to the present invention, it is preferable that the microlens for phase difference detection is manufactured to have the radius of curvature of 0.5 mm to 1.5 mm such that light incident in the range of 0° to 120° can be collected only in one direction.

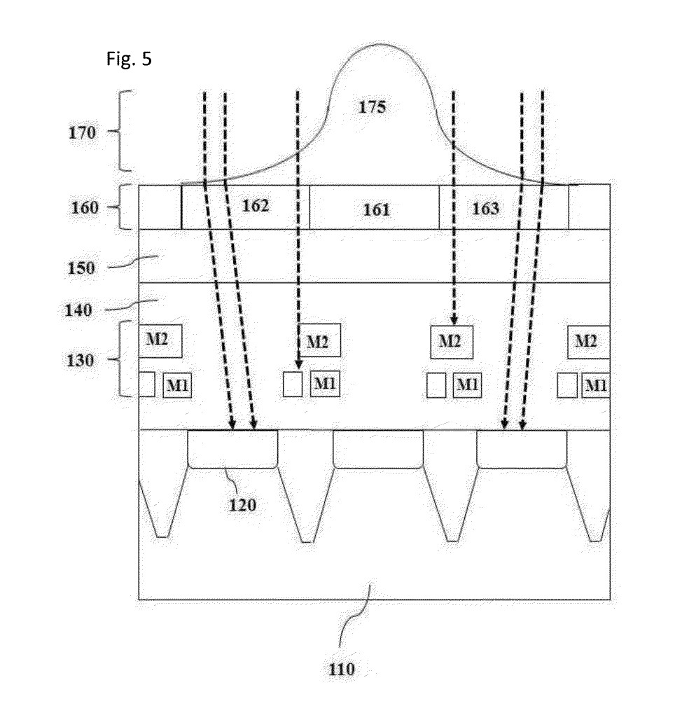

FIG. 5 is a diagram illustrating further another embodiment of a phase difference detection pixel using a microlens according to the present invention.

As illustrated in FIG. 5, in the phase difference detection pixel using a microlens according to the present invention, a microlens for phase difference detection, which allows light to be incident only in a specific direction with respect to two pixels having the same color, is integrally formed with a conventional general microlens, so that one microlens 175 may be obtained.

In the case of the phase difference detection pixel illustrated in FIG. 5, since there is no dead zone between the microlens for phase difference detection according to the present invention and the general microlens, it is possible to improve the size of a signal and to block light collected in an adjacent pixel by adjusting the radius of curvature of a lens.

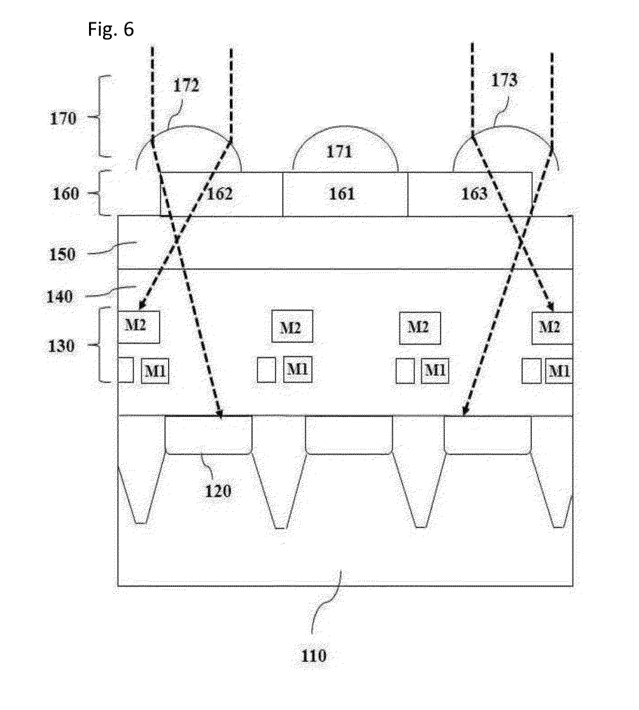

FIG. 6 is a diagram illustrating further another embodiment of a phase difference detection pixel using a microlens according to the present invention.

In the phase difference detection pixel using a microlens according to the present invention, the shape of the microlens may be variously modified. Referring to FIG. 6, in the phase difference detection pixel using a microlens according to the present invention, the positions of a first microlens 172 for phase difference detection and a second microlens 173 for phase difference detection are moved, so that light can be incident only in a specific direction with respect to two pixels having the same color.

The degree of movement of the first microlens 172 for phase difference detection and the second microlens 173 for phase difference detection may be changed according to whether the phase difference detection pixel using a microlens according to the present invention is positioned in the center or the outer peripheral area of an image sensor.

Also in this case, instead of one microlens, two or more microlenses manufactured to have a small size may be arranged with respect to the first microlens 172 for phase difference detection and the second microlens 173 for phase difference detection.

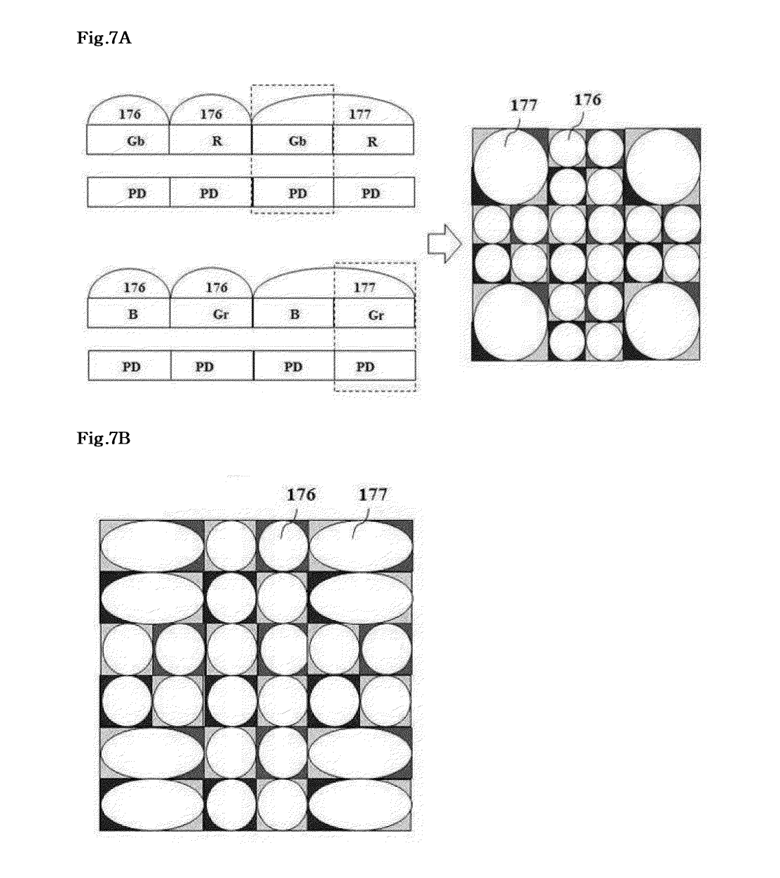

FIG. 7A and FIG. 7B are a diagram illustrating further another embodiment of a phase difference detection pixel using a microlens according to the present invention.

For an area to be used as the phase difference detection pixel, one microlens is formed in a plurality of pixels.

That is, referring to FIG. 7A, in a structure having an array of green Gr, red R, green Gr, and blue B pixels, general microlenses 176 are formed with respect to general pixels, so that light incident from an exterior can be collected in all directions. However, one microlens 177 for phase difference detection is formed for four pixels with respect to pixels Gb and Gr used in phase difference detection, so that light incident from an exterior can be collected only in a specific direction.

The phase difference detection is performed using pixels having the same color Gr and Gb, and the red R and blue B pixels are not used in the phase difference detection.

In the case of using one microlens 177 for phase difference detection in order to detect a phase difference, since light is allowed to be collected only in a specific direction, the size of a signal may be small. Accordingly, the values of peripheral pixels are used in image expression, so that it is possible to prevent resolution reduction.

As illustrated in FIG. 7B, it may be possible to use a structure in which one microlens 177 for phase difference detection is used for two color filter arrays.

A phase difference is obtained in the same method as the structure in which one microlens 177 for phase difference detection is used for four color filter arrays illustrated in FIG. 7A, and since the size of an incident direction of light is large as compared with (a), the size of a signal is increased.

Furthermore, since the shape of the microlens 177 for phase difference detection is not a square but a rectangle, rectangles are arranged in a horizontal or vertical direction according to positions in order to obtain a phase difference in all directions of an image sensor.

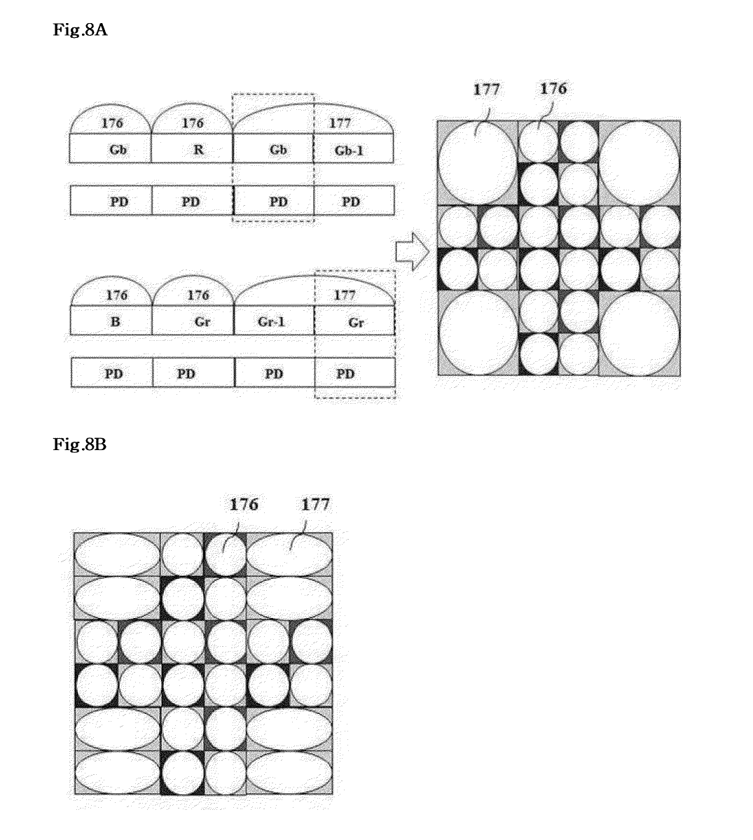

FIG. 8A and FIG. 8B are a diagram illustrating further another embodiment of a phase difference detection pixel using a microlens according to the present invention.

Referring to FIG. 8A and FIG. 8B, microlenses 176 are formed with respect to general pixels, so that light incident from an exterior can be collected in all directions. In the case of pixels for phase difference detection, with respect to four pixels, green filters are formed and one microlens 177 for phase difference detection is formed, so that light incident from an exterior can be collected only in a specific direction.

In the case of the pixel structure illustrated in FIG. 7A and FIG. 7B, since signal extraction times of the green Gr and Gb pixels are not equal to each other, an error may occur in phase difference detection. However, in the case of the structure illustrated in FIG. 8A and FIG. 8B, the same color of green filters are used for the same line of pixels, so that a phase difference can be obtained without such an error even when the amount of incident light is small.

FIG. 7A and FIG. 7B and FIG. 8A and FIG. 8B illustrate that one microlens is used for two and four pixels, but the number of the pixels can be expanded to two or more.

As described above, in accordance with the phase difference detection pixel using a microlens according to the present invention, it is possible to solve a signal reduction problem that is a disadvantage of the existing phase difference detection pixel, and to achieve a phase difference detection function in all areas of an image sensor.

Furthermore, it is advantageous that the phase difference detection pixel using a microlens according to the present invention can be variously applied for distance measurement between objects or three-dimensional image capturing, as well as a function of simply detecting a phase difference.

While various embodiments have been described above, it will be understood to those skilled in the art that the embodiments described are by way of example only. Accordingly, the disclosure described herein should not be limited based on the described embodiments.

What is claimed is:

1. A phase difference detection pixel using a microlens, comprising:
photodiodes formed in a semiconductor substrate;
a metal interconnection layer formed on the photodiodes;
an insulating layer formed on the metal interconnection layer;
a color filter layer formed on the insulating layer and including a general color filter and a pair of color filters for phase difference detection; and
a microlens layer including a general microlens formed on the general color filter and microlenses for phase difference detection formed on the pair of color filters for phase difference detection,
wherein the microlenses for phase difference detection comprise:
a first microlens for phase difference detection having a shape obtained by quartering a convex lens about a center of the convex lens in a horizontal direction and a vertical direction and provided at one side thereof with a first incidence surface inclined and curved; and
a second microlens for phase difference detection having a shape obtained by quartering the convex lens about the center of the convex lens in the horizontal direction and the vertical direction and provided with a second incidence surface inclined and curved in an opposite direction of the first microlens for phase difference detection,
wherein the microlenses for phase difference detection are formed with respect to the color filters for phase difference detection such that light incident in a specific direction is collected in the photodiodes corresponding to the color filters for phase difference detection.

2. A phase difference detection pixel using a microlens, comprising:
photodiodes formed in a semiconductor substrate;
a metal interconnection layer formed on the photodiodes;
an insulating layer formed on the metal interconnection layer;
a color filter layer formed on the insulating layer and including a general color filter and a pair of color filters for phase difference detection; and
a microlens layer including a general microlens formed on the general color filter and microlenses for phase difference detection formed on the pair of color filters for phase difference detection,
wherein the microlenses for phase difference detection comprise:
a first microlens for phase difference detection having a shape obtained by quartering a concave lens about a center of the concave lens in a horizontal direction and a vertical direction and provided at one side thereof with a first incidence surface inclined and curved; and
a second microlens for phase difference detection having a shape obtained by quartering the concave lens about the center of the concave lens in the horizontal direction and the vertical direction and provided with a second incidence surface inclined and curved in an opposite direction of the first microlens for phase difference detection,
wherein the microlenses for phase difference detection are formed with respect to the color filters for phase difference detection such that light incident in a specific direction is collected in the photodiodes corresponding to the color filters for phase difference detection.

3. The phase difference detection pixel using a microlens according to claim 1, wherein the pair of color filters for phase difference detection have a same color.

4. The phase difference detection pixel using a microlens according to claim 1, further comprising:
a protective layer between the insulating layer and the color filter layer.

5. The phase difference detection pixel using a microlens according to claim 1, further comprising:
blocking layers formed between the pair of color filters for phase difference detection and the general color filter.

6. The phase difference detection pixel using a microlens according to claim 1, further comprising:
Stack filter layers formed between the pair of color filters for phase difference detection and the general color filter.

7. The phase difference detection pixel using a microlens according to claim 1, wherein a plurality of first microlenses for phase difference detection and a plurality of second microlenses for phase difference detection are formed on the pair of color filters for phase difference detection, respectively.

8. The phase difference detection pixel using a microlens according to claim 1, wherein the microlens for phase difference detection has a radius of curvature of 0.5 mm and 1.5 mm.

9. The phase difference detection pixel using a microlens according to claim 1, wherein, even when the phase difference detection pixel using a microlens is arranged in any one of center and peripheral areas of an image sensor, phase difference detection is performed.

10. The phase difference detection pixel using a microlens according to claim 1, wherein the phase difference detection pixel using a microlens is applied to a front side illumination (FSI) image sensor and a back side illumination (BSI) image sensor.

11. The phase difference detection pixel using a microlens according to claim 1, wherein the phase difference detection pixel using a microlens is applied for distance measurement between objects or three-dimensional image capturing.

12. The phase difference detection pixel using a microlens according to claim 2, wherein the microlens for phase difference detection is connected to the general microlens and is integrally formed with the general microlens.

13. A phase difference detection pixel using a microlens, comprising:
photodiodes formed in a semiconductor substrate;
a metal interconnection layer formed on the photodiodes;
an insulating layer formed on the metal interconnection layer;
a color filter layer formed on the insulating layer and including a general color filter and a pair of color filters for phase difference detection; and
a microlens layer including a general microlens formed on the general color filter and microlenses for phase difference detection formed on the pair of color filters for phase difference detection,
wherein the microlenses for phase difference detection are vertically spaced apart from an upper portion of the pair of color filters for phase difference detection by a predetermined distance in an opposite direction on a basis of the general microlens.

14. The phase difference detection pixel using a microlens according to claim 13, wherein the microlenses for phase difference detection are formed on the pair of color filters for phase difference detection, respectively.

15. A phase difference detection pixel using a microlens, comprising:
photodiodes formed in a semiconductor substrate;
a metal interconnection layer formed on the photodiodes;
an insulating layer formed on the metal interconnection layer;
a color filter layer formed on the insulating layer and including a general color filter and a color filter for phase difference detection; and
a microlens layer including a general microlens formed on the general color filter, and one microlens for phase difference detection formed on the color filter for phase difference detection and formed with respect to the color filter for phase difference detection such that light incident in a specific direction is collected in the photodiodes corresponding to the color filter for phase difference detection,
wherein the one microlens for phase difference detection is formed with respect to at least two color filters for phase difference detection, and
a protective layer is further provided between the insulating layer and the color filter layer.

16. The phase difference detection pixel using a microlens according to claim 15, wherein a red R filter, a green Gr filter, a blue B filter, and the green Gr filter are formed under the microlens for phase difference detection.

17. The phase difference detection pixel using a microlens according to claim 15, wherein a red R filter and a green Gr filter, or a blue B filter and the green Gr filter are formed under the microlens for phase difference detection.

18. The phase difference detection pixel using a microlens according to claim 15, wherein two or four green Gr filters are formed under the microlens for phase difference detection.

19. The phase difference detection pixel using a microlens according to claim 2, wherein the pair of color filters for phase difference detection have a same color.

20. The phase difference detection pixel using a microlens according to claim 2, further comprising:
a protective layer between the insulating layer and the color filter layer.

21. The phase difference detection pixel using a microlens according to claim 2, further comprising:
blocking layers formed between the pair of color filters for phase difference detection and the general color filter.

22. The phase difference detection pixel using a microlens according to claim 2, further comprising:
Stack filter layers formed between the pair of color filters for phase difference detection and the general color filter.

23. The phase difference detection pixel using a microlens according to claim 2, wherein a plurality of first microlenses for phase difference detection and a plurality of second microlenses for phase difference detection are formed on the pair of color filters for phase difference detection, respectively.

24. The phase difference detection pixel using a microlens according to claim 2, wherein the microlens for phase difference detection has a radius of curvature of 0.5 mm and 1.5 mm.
